(19) United States
(12) Patent Application Publication
(10) Pub. No.: US 2003/0011628 A1
(43) Pub. Date: Jan. 16, 2003

(54) Method and apparatus for a portable digital assistant device having improved data input

(76) Inventor: John T. Piatek, Traverse City, MI (US)

Correspondence Address: Price, Heneveld, Cooper, DeWitt & Litton, 695 Kenmoor, S.E., Post Office Box 2567, Grand Rapids, MI, 49501, US

(21) Appl. No.: 10/132,707

(22) Filed: Apr. 25, 2002

Related U.S. Application Data
(60) Provisional application No. 60/286,312, filed on Apr. 25, 2001.

(51) Int. Cl. G09G 5/00

(52) U.S. Cl. 345/700

(57) ABSTRACT

A Portable Data Assistant (PDA) inputs non-conventional data such as barcode data from a barcode reading device (i.e., a barcode scanner) into an application program running on the PDA. A special input routine (SIR) is loaded into the PDA for inputting and processing data received from the non-conventional input device. The SIR scans the input data and verifies that it contains valid data for the target application program. The input data is remapped, if needed, responsive to instructions in a configuration file. For example, barcode data may be remapped to predefined ASCII characters. The input data is then communicated to the application program via conventional communications paths compatible with the application program.

### CROSS-REFERENCE TO RELATED APPLICATION

This application claims priority under 35 U.S.C. §119(e) on U.S. Provisional Patent Application No. 60/286,312, entitled “METHOD AND APPARATUS FOR A PORTABLE DIGITAL ASSISTANT DEVICE HAVING IMPROVED DATA INPUT,” filed on Apr. 25, 2001, by John T. Piatek.

### TECHNICAL FIELD

The present invention generally relates to Portable Digital Assistants (PDAs) and, more particularly, to PDAs that input data from non-conventional input devices such as barcode scanners, infrared scanners, and the like.

### BACKGROUND OF THE INVENTION

The proliferation of new PDA devices, also commonly referred to as Personal Data Assistants, is occurring. PDAs are small, portable computing devices that perform a variety of tasks such as address book, calendar, memo pad, checklist and the like. Many PDAs use a touchscreen for communicating data to a user and for receiving input from a user. Generally, PDAs are small enough to be held in one hand and fit into a pocket.

Some PDAs can communicate with various non-conventional input devices, some of which are integrated into the PDA itself. Non-conventional input devices include barcode-reading devices (i.e., barcode scanners), infrared receivers, wireless receivers, RFID tags (radio frequency identification tags), and various electromagnetic radiation receivers to mention a few.

A problem with PDAs is the inability of many application programs to communicate with non-conventional input devices. For example, a commercial database program is unlikely to support the unique interface requirements of a non-conventional input device. A reason this is a problem is that the operating systems of many PDAs do not support multitasking (i.e., the ability of an operating system to run more than one software application at a time). Consequently, non-conventional input devices can only be used by one program at a time. The result is that each application program must be designed to support interfacing with the specific non-conventional input device. It is extremely rare for most programs to support such interfacing requirements. A solution for some programs is creating a customized version of the application program. However, this generally requires editing source code, compiling, and linking the program to create a customized executable application program that supports the non-conventional input device.

The problem is further complicated for commercial off-the-shelf programs. These programs are written to operate on conventional PDAs and therefore generally do not support or interface to non-conventional input devices. Further, a user is unlikely to have access to the program's source code and is therefore prevented from virtually any attempt to create a useable executable program.

In a computer system running a multitasking operating system, this problem may be remedied by loading a driver program that handles the interface between the application program and the input device. Unfortunately, as mentioned above, the operating systems for many PDAs do not support multitasking and this solution is unavailable.

As a result, there is a limited selection of application programs that can run on PDAs and interface with non-conventional input devices.

Accordingly, it is therefore desirable to provide a solution so PDAs that are connected with non-conventional input devices may interface the input devices with conventional application programs without the wasted time and expense of creating customized versions of the application programs.

### SUMMARY OF THE INVENTION

The present invention solves the problems associated with the prior art and eliminates the need for customized application programs. The invention provides for a PDA that automatically inputs data from a non-conventional input device and communicates the data to an application program running on the PDA. This is accomplished using a special input routine (SIR) that is loaded into memory and interfaces with the operating system of the PDA. The SIR configures the non-conventional input device and receives and processes data from the device. The data is verified as valid data for the target application program. If desired, the data is remapped responsive to instructions in a configuration file. For example, some or all of the data may be remapped to predefined ASCII characters. The SIR then communicates the data to the application program by emulating the on-screen keyboard routine or similar input routine.

The invention takes over the task of interfacing with a non-conventional input device. The task shifts from the application program level to the operating system level. Conventional PDA operating systems, such as the Palm OS®, typically allow just two methods for inputting data to an application program. The two common methods are an on-screen keyboard and a text (or handwriting) input routine, both of which are implemented on the touch sensitive display screen of the PDA. For example, the Palm OS® has the on-screen keyboard routine and the Graffiti® text input routine for inputting data. In the prior art, input from a non-conventional input device is handled at the application program level. The application program makes specific program calls to activate and control the non-conventional input device. Palm OS® and Graffiti® are registered trademarks of Palm, Inc.

The invention creates a new input routine, the SIR, at the operating system level. The SIR operates as a third method for inputting data in addition to Graffiti® and the on-screen keyboard routine. Graffiti® and the on-screen keyboard allow a user to enter data into any application running on a Palm OS® powered PDA. Similarly, the SIR allows a user the same flexibility to enter data from a non-conventional input device into any application program just as if the data were entered by Graffiti® or the on-screen keyboard.

The method and invention calls for the SIR to be added to an intermediate space between the unalterable Palm OS® proprietary layer and the application program space. This intermediate space is open to programmers to add devices, such as a connected keyboard, for inputting information to any application program that is running. Such a keyboard typically interfaces with the PDA through externally exposed electrical contact terminals. This method and invention, for example, permits a barcode scanner to be added as another functional keyboard. In addition to the functionality of an additional input device, the invention further provides for validating and translating data from the non-conventional input device.

These and other features, advantages, and objects of the present invention will be further understood and appreciated by those skilled in the art by reference to the following specification, claims, and appended drawings.

### BRIEF DESCRIPTION OF THE DRAWINGS

The present invention will now be described, by way of example, with reference to the accompanying drawings, in which:

FIG. 1 is a PDA;

FIGS. 2A and 2B are block diagrams of PDAs;

FIG. 3 is a flowchart of the SIR;

FIG. 4 is a sample of configuration file syntax; and

FIG. 5 is a table of non-displayed character codes.

### DESCRIPTION OF THE PREFERRED EMBODIMENT

The invention is applicable for use with most non-conventional input devices; however, the preferred embodiment interfaces with a barcode reading device. For descriptive purposes, the invention will be described in relation to this embodiment although it is understood that the invention is applicable to other non-conventional input devices. Further, since the invention is applicable to the Palm OS® operating system, which is the leading operating system for PDAs at this time, this specification will describe the invention in relation to this operating system. However, it is understood that the invention has application to other operating systems. Palm OS® is a registered trademark of Palm, Inc., of Santa Clara, Calif.

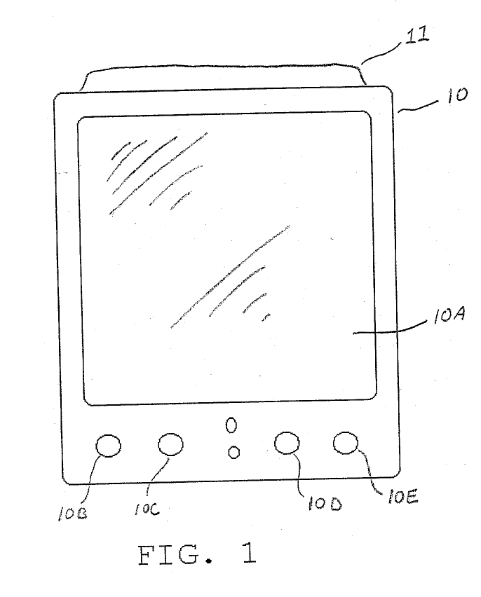

Turning to FIG. 1, a PDA 10 is shown equipped with a barcode reading device (i.e., barcode scanner) 11. Barcode reading device 11 may be any of a variety of barcode reading devices ranging from integral devices to after-market devices that plug into an expansion slot or communications port of PDA 10. PDA 10 has conventional features that include touchscreen display 10A, calendar button 10B, address book button 10C, checklist button 10D, and memo pad button 10E. Touchscreen 10A is used as the primary input/output device and operates with a stylus to enter data via either the on-screen keyboard routine or the Graffiti® text input routine.

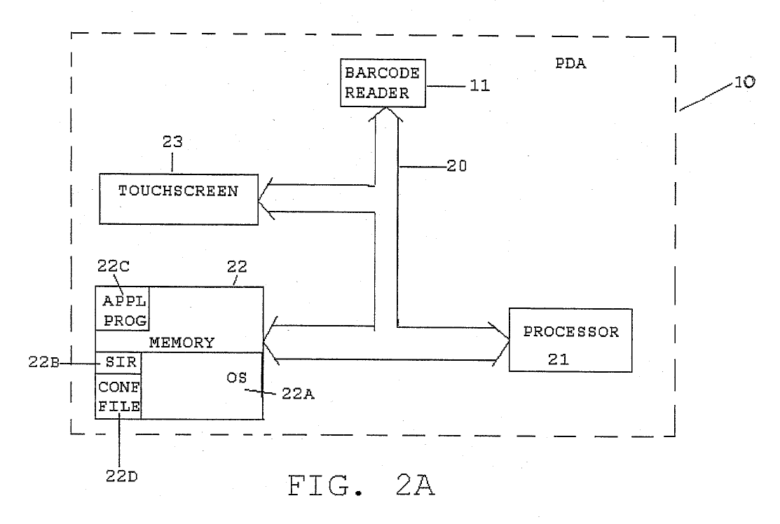

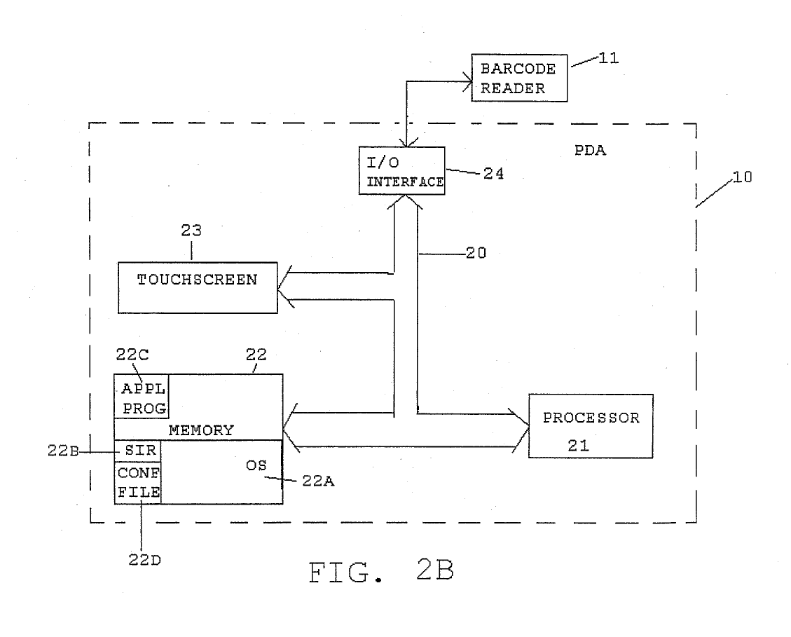

Turning to FIGS. 2A and 2B, there are illustrated block diagrams of two embodiments of the invention. FIG. 2A illustrates the invention embodied as having a barcode reading device 11 as an integral part of PDA 10. Barcode reading device 11 is in communication with memory 22 and processor 21 via communications bus 20. Processor 21 executes operating system programs 22A and application programs 22C located in memory 22. Processor 21 also processes data stored in memory 21, input from touchscreen 23, and input from barcode reading device 11. Memory 22 preferably includes both RAM and ROM portions for storing variable and static data, respectively. Operating system 22A, SIR 22B, applications programs 22C, and configuration file 22D are stored in memory 22. Configuration file 22D is a data file used by SIR 22B and is described below. During runtime, SIR 22B is added to the space between the unalterable Palm OS® proprietary layer and the application program layer as mentioned above.

A second embodiment shown in FIG. 2B illustrates a barcode reader 11 that is not integral with the PDA 10. Barcode reader 11 may be virtually any input device capable of being connected to a PDA including infrared receivers, RFID tags, and various other electromagnetic radiation receivers to name a few. Barcode reader 11 is in communication with PDA 10 via I/O interface 24. I/O interface 24 facilitates communications between barcode reader 11 and bus 20.

The instructions in SIR 22B are executed by processor 21 and thereby handle communications with barcode reader 11 such as activation, configuration, handshakes, input/output of data, validation, and the like. When valid data is received from the barcode reader 11, SIR 22B causes the data to be communicated to application program 22C running on the processor 21 just as if the data were keystrokes entered by the on-screen keyboard routine or text input from the Graffiti® routine. In other words, SIR 22B emulates the application interfaces with the on-screen keyboard and the Graffiti® routine. SIR 22B becomes an additional input method for adding data to the on-screen data fields of the application programs.

SIR 22B is preferably automatically loaded by the operating system 22A when PDA 10 is turned on or unsuspended. SIR 22B may also be halted or restarted via a manual operation system command.

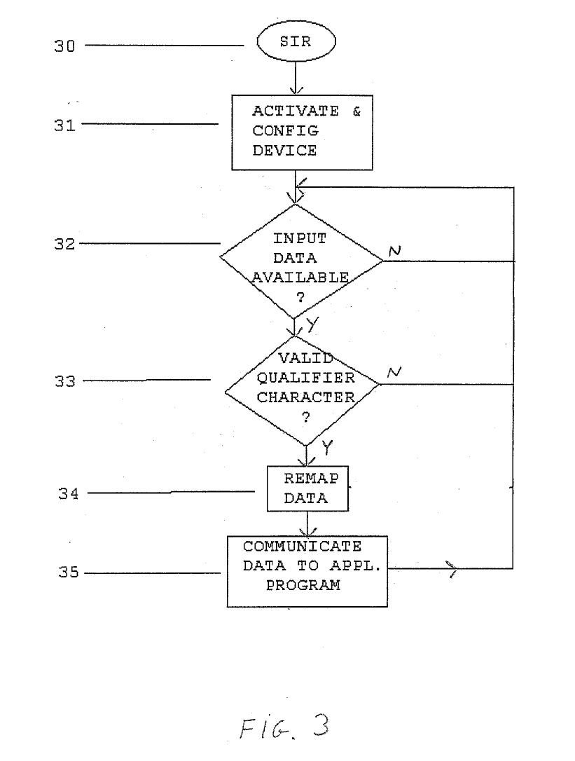

Operation of SIR 22B is more clearly explained by example. Referring to FIG. 3, there is shown a flowchart of SIR 22B. The routine begins at step 30 and immediately proceeds to step 31 where the barcode reader is activated and configured. The routine waits for data to become available from barcode reader 11 (step 32). The qualifying character is checked for validity (step 33). If no valid qualifying character is found, the data is discarded and the routine returns to step 32. When a valid qualifying character is found, the routine proceeds to step 34 where the input data is remapped responsive to instructions in a configuration file. Finally, the data is communicated to the application program (step 35). The data is communicated to the application program in a manner similar to how data is communicated from conventional input routines such as the on-screen keyboard routine.

The data is input and displayed to the current active screen. For example, if the barcode reader scans a two-dimensional barcode that contains: “Hi, I am John <enter> My address is 121 East Front Street <enter> and this is a PDA.” The text data would be displayed on any screen that is currently showing just as if it had been had been entered by the on-screen keyboard routine. The application program 22C processes the data in a conventional manner.

Upon being loaded by the operating system, SIR 22B preferably checks for a configuration that contains instructions for validating and remapping data from the barcode reader 11. Typically, a configuration file is specific to an application program. In the absence of a custom configuration file, a default configuration file is used. The configuration files are preferably text files and therefore easily created. The user selects a desired configuration file from a list or by other methods. The configuration file has specific syntax that is easily parsed by SIR 22B.

A user operating the PDA may scan a variety of barcodes. SIR 22B preferably should ensure that the scanned barcode is valid for the target application program 22C running on the PDA 10. Therefore, the barcodes are made to contain a unique identifier code. This unique identifier, called a qualifier, is preferably the first code in the barcode. SIR 22B compares the qualifier from the barcode to the qualifier code in the configuration file. If the codes match, the process continues. If the codes do not match, the remaining barcode data is discarded.

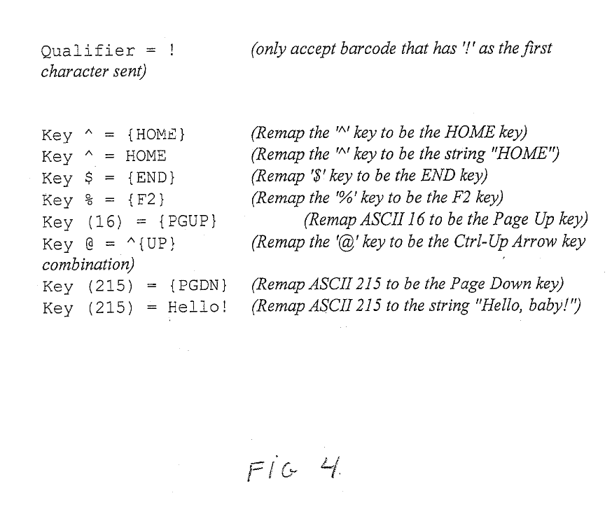

Turning to FIG. 4, there is illustrated a configuration file and preferred syntax. In this example, the qualifying character is “!.” Line 2 remaps the ASCII code for “ˆ ” to the HOME key. The comments on the right side of the figure are self-explanatory.

Virtually any useful re-mapping scheme may be used, however, and typically values between 0- 255 are remapped to remain consistent with conventional ASCII characters. Special characters such as non-display characters and control characters are specified as described below.

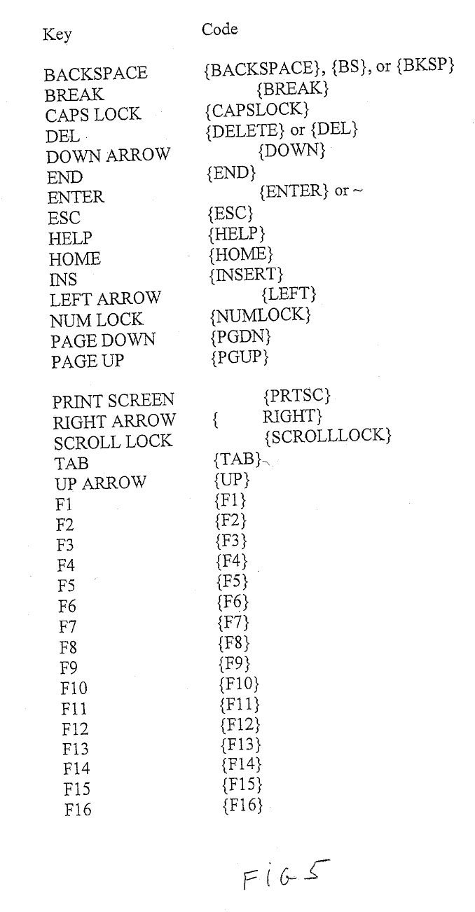

To specify characters that are not displayed when a key is pressed (e.g., ENTER and TAB) and keys that represent actions rather than characters, the codes illustrated in FIG. 5 are used. For example, to represent the BACKSPACE key, the codes {BACKSPACE}, {BS}, or {BKSP} may be used. Codes for many non-displayed characters are illustrated in FIG. 5.

To specify keystrokes combined with any combination of the SHIFT, CTRL, and ALT keys, the regular code is preceded with one or more of the following codes:

| Key | Code |
|---|---|
| SHIFT | + |
| CTRL | \hat{ } |
| ALT | % |

To specify that any combination of SHIFT, CTRL, and ALT should be held down while several other keys are pressed, enclose the code for those keys in parentheses. For example, to specify the code for holding down the SHIFT key while E and C are pressed, use “+(EC).” To specify the code for holding down the SHIFT while E is pressed, followed by C without SHIFT, use “+EC.” ASCII values not represented on the keyboard are entered as a number surrounded by parenthesis.

SIR 22B performs some error checking on the configuration file. First, the file is checked for the existence of a qualifier. If no qualifier is present, the configuration file is rejected. Second, syntax checking is performed for the remainder of the file. Obviously, syntax checking can vary in complexity, however, only nominal syntax checking is normally necessary. The parsing and syntax checking can always be improved to satisfy a particular requirement.

Additional syntax rules are applied to the configuration file. Each line is allowed to contain only one instruction. For example:

Qualifier=x

This command sets the qualifier to the character code “x.” Referring again to the barcode embodiment, SIR 22B compares the first character/code from the barcode scanner to the character “x.” If it does not match, then the remaining data is ignored.

By way of further example:

KeyX=Y

Or

Key (216)=Y

These statements specify that either a scanned code of “X” or the number 216 will be translated into the code for the Y key (i.e., it simulates the capital Y key being pressed).

Another aspect of the configuration file is the Stop and Start instructions. For example:

Stop=X

This statement instructs SIR 22B to stop sending data to the application program when the X character code is received. Similarly:

Start=Y

Instructs the SIR 22B to resume sending data to the application program after the Y character code is received. In the preferred embodiment, it is assumed that the next character code received after the Y will be a qualifier.

The method of the invention follows from the description above. First, an SIR is loaded to the operating system of the PDA. The SIR contains instructions that cause processor 21 to read the appropriate configuration file. The input device is activated and configured by processor 21 under the control of SIR 22B. Data is input from the barcode reader 11 and processed by processor 21 according to instructions in SIR 22B. SIR 22B instructs processor 21 to look for a valid qualifier code. If the valid qualifier code is found, processor 21 maps or translates the barcode data according to instructions in configuration file 22D. The data is then communicated to the application program via the application program's normal input routines.

The initial prototype was created using a Symbol Technologies SPT 1XXX scanner which is a Palm OS® based PDA with a built-in barcode reader. A technical description of this prototype follows. A software program used to implement the SIR in the prototype is called HackMaster.

HackMaster is a program for managing extensions to the Palm OS® software, known as “Hacks.” Typically, such extensions hook themselves into one of the many system routine traps and thus are called in addition to or in lieu of the standard Palm OS® routines. The application type for a Hack file is ‘HACK’, instead of ‘appl’.

SIR 22B is implemented with three components. The first component, PalmScanHack.Prc, contains the instructions for enabling the Symbol SPT 1XXX scanner. The second component, HackMaster, is a program that allows files, such as PalmScanHack, to function in the Palm operating system. The third is source code from Symbol Technologies ScanMgr.Lib, which controls the functionality of the scanner on the Symbol SPT 1XXX Palm PDAs.

Since the Symbol Technologies ScanMgr.Lib is a shared library, meaning it is attached to a particular application, the Symbol scanner can only be invoked by coding it to an application. The Palm OS® does not allow for more than one application program to be running at one time. So typically, scanning applications that are created for scanning on the Palm OS® only function when the application that has been modified to interface with the barcode reader is running. The inventive application eliminates the need to modify the application programs and calls for the scanner to be operational whenever the user desires it, simulating a multitasking environment. Barcode reader 11 is not linked to any particular application. It does not need any user programming to utilize the scanner.

SIR 22B is implemented as a HackMaster hack (module) that intercepts the Palm OS® system event trap. If a barcode reader related event happens, the SIR intercepts it and deals with it appropriately (enable/disable the barcode reader, decode reader data, etc.). If it is not a barcode reader event, then the event is sent to the original system event trap. This is accomplished by using the Symbol ScanMgr shared library.

The PalmScanHack.PRC file codes a Hack to the standard keyboard dialog with a new input method (e.g., the barcode reader on the SPT 1XXX Palm PDAs). The result is that there are now at least three input methods, on-screen keyboard, Graffiti and barcode reader. The user invokes the barcode reader at any time by tapping on the top “V” in the Graffiti area. A message is displayed that says “Scanner Enabled.” The user is now ready to read barcodes into the active application. To disable the scanner, the user simply leaves the application or taps on the bottom “Λ” in the Graffiti area, the scanner is disabled and a message is displayed “Scanner Disabled.” The barcoded data is sent to the active application as keystrokes. Data is input to the area of focus on the active screen, much the same as if the user typed in information using the Palm on-screen keyboard routine.

HackMaster resolves many of the problems associated with implementing these types of routines. HackMaster reads in special PalmPilot resource files of type ‘HACK’, which contain the code for the patch and also whatever user interface routines are necessary. Then, HackMaster presents a standard interface to the user for installing and removing Hacks, and for changing their configurations. It handles such things as installing and removing the trap patches and keeping track of multiple Hacks on the same trap. It also saves the current extension configuration so that they can all be automatically (or optionally) reinstalled on a system reset. Because of these reasons, HackMaster is a useful prototyping tool.

Further technical description is available at the HackMaster web site that is located at www.daggerware.com. Technical instructions for writing “hacks” are located at the Internet URL address www.daggerware.com/hackapi.htm and this site is included herein by reference. It is envisioned that a production version of the invention would be implemented with custom software and therefore the HackMaster program would not be necessary.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

The invention claimed is:

1. A portable data assistant (PDA) comprising:
a processor;
a memory in communication with said processor;
a barcode scanner in communication with said processor; and
a special input routine (SIR) loaded in said memory, said routine including instructions for retrieving barcode data from said scanner and using a qualifier code for validating said barcode data.

2. The PDA according to claim 1, further comprising a non-multitasking operating system loaded in said memory and wherein said SIR is loaded into memory which is part of said operating system.

3. The PDA according to claim 1, further comprising a configuration file accessible by said processor unit, said configuration file containing remapping data.

4. The PDA according to claim 1, wherein said SIR is loaded into an operating system area of said memory between the proprietary layer and the user application space.

5. The PDA according to claim 1, wherein said SIR is loaded into an operating system layer of said memory exclusive of the proprietary layer and the user application space.

6. A PDA comprising:
a processor;
a memory in communication with said processor;
a non-conventional input device in communication with said processor;
an SIR loaded into a portion of said memory other than the memory specified for application programs, said routine including instructions for retrieving and validating data from said input device.

7. The PDA device according to claim 6, wherein said SIR includes instructions for remapping said data responsive to instructions in a configuration file.

8. The PDA device according to claim 6, wherein said SIR is loaded into an operating system area of said memory between the proprietary layer and the user application space.

9. The PDA device according to claim 6, wherein said SIR communicates said data to an applications program using the application program's conventional input routine.

10. A method of interfacing with a non-conventional input device in communication with a PDA having a non-multitasking operating system, the method comprising the steps of:
adding an SIR to the operating system memory of the PDA;
the SIR processing data from said non-conventional input device;
scanning the data for a qualifier code;
discarding the data if the qualifier code is not found; and
communicating the input data to an application program.

11. The method of processing input data in a PDA according to claim 10, wherein the step of communicating the input data to an application program includes communicating the input data to an application program via the application program's conventional input routines.
